(19) United States
(12) Patent Application Publication
(10) Pub. No.: US 2005/0269769 A1
(43) Pub. Date: Dec. 8, 2005

(54) Handheld controller

(76) Inventors: Herschel Naghi, Los Angeles, CA (US); Craig S. Erickson, Stevenson Ranch, CA (US); Amir Navid, Sherman Oaks, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 10/862,777

(22) Filed: Jun. 7, 2004

(51) Int. Cl. A63F 9/24; A63F 13/00; G06F 17/00

(52) U.S. Cl. 273/148 B; 463/36

(57) ABSTRACT

A handheld controller for manipulating objects on a video screen includes a handheld controller housing having right and left handgrips where a user grips the handheld controller with right and left hands; more than one select hand ventilation area that air moves through to the user's hand to cool the user's hand during use, the more than one select hand ventilation area including multiple ventilation holes therein to allow air to move from an inside of the handheld controller housing to an outside of the handheld controller housing, the more than one select hand ventilation area located in less than the entirety of at least the right and left handgrips; means for manipulating objects on a video screen; and an internal fan assembly within the handheld controller to move air through the multiple ventilation holes from the inside of the housing to the outside of the housing.

### FIELD OF THE INVENTION

The present invention, in general, is in the field of handheld controllers such as controllers used to manipulate objects on a video screen, and, in particular, in the field of such handheld controllers that are also ventilated to keep a user's hand dry and prevent perspiration.

### BACKGROUND OF THE INVENTION

U.S. Pat. No. 6,241,247 describes a controller for manipulating icons on a video display. The controller reduces or substantially eliminates perspiration on the user's hands during extended use. The controller includes a housing with finger operated buttons that control the video game. The housing includes ventilation holes to allow air to circulate through the controller and between the housing and the user's hands. The housing encloses electronic components that are contained in a protective package that can be removed from the housing so that it can be easily and thoroughly cleaned. The ventilation holes may be located over the entire housing or may be located only at locations on the housing that are intended to be grasped by the user.

### SUMMARY OF THE INVENTION

The present invention represents an improvement over the controller described above. An aspect of the present invention involves a handheld controller for manipulating objects on a video screen. The handheld controller includes a handheld controller housing including a right handgrip and a left handgrip where a user grips the handheld controller with a right hand and a left hand, respectively; more than one select hand ventilation area where air moves through the ventilation area to the user's hand to cool the user's hand during use of the handheld controller, the more than one select hand ventilation area including multiple ventilation holes therein to allow air to move from an inside of the handheld controller housing to an outside of the handheld controller housing, the more than one select hand ventilation area located in less than the entirety of at least the right handgrip and the left handgrip; means for manipulating objects on a video screen; and an internal fan assembly within the handheld controller to move air through the multiple ventilation holes from the inside of the housing to the outside of the housing.

Implementations of the above aspect of the invention may include one or more of the following. The right handgrip and the left handgrip include outer palm grip areas corresponding to where a user's palms would be disposed when grabbing the handheld controller, and the more than one select hand ventilation area located in less than the entirety of at least the right handgrip and the left handgrip includes at least a select ventilation area in the outer palm grip areas of the right handgrip and the left handgrip. The right handgrip and the left handgrip include inner finger grip areas corresponding to where at least an upper portion of a user's fingers would be disposed when grabbing the handheld controller, and the more than one select hand ventilation area located in less than the entirety of at least the right handgrip and the left handgrip further includes at least a select ventilation area in the inner finger grip areas of the right handgrip and the left handgrip. The right handgrip and the left handgrip include areas corresponding to where the thumbs and adjoining palm areas would be disposed when grabbing the handheld controller, and the more than one select hand ventilation area located in less than the entirety of at least the right handgrip and the left handgrip further includes at least a select ventilation area in the areas corresponding to where the thumbs and adjoining palm areas would be disposed when grabbing the handheld controller of the right handgrip and the left handgrip. The right handgrip and the left handgrip include areas corresponding to where the lower part of the user's fingers would be disposed when grabbing the handheld controller, and the more than one select hand ventilation area located in less than the entirety of at least the right handgrip and the left handgrip further includes at least a select ventilation area in the areas corresponding to where the lower part of the user's fingers would be disposed when grabbing the handheld controller of the right handgrip and the left handgrip. The more than one select hand ventilation area includes at least one spacer to space the user's hands from the multiple ventilation holes. The internal fan assembly is a multi-speed fan assembly and further including a multi-position switch carried by the housing to control the multi-speed fan assembly. The handheld controller housing includes a central section with the internal fan assembly located therein. The handheld controller housing includes a central section with a top and a bottom, and the handheld controller housing includes a fan intake in the bottom of the central section where air is drawn from outside the handheld controller into the housing and to the internal fan assembly.

Another aspect of the invention involves a handheld controller for manipulating objects on a video screen including a handheld controller housing including a right handgrip and a left handgrip where a user grips the handheld controller with a right hand and a left hand, respectively, the right handgrip and the left handgrip including outer palm grip areas corresponding to where a user's palms would be disposed when grabbing the handheld controller, inner finger grip areas corresponding to where at least an upper portion of a user's fingers would be disposed when grabbing the handheld controller, areas corresponding to where the thumbs and adjoining palm areas would be disposed when grabbing the handheld controller, areas corresponding to where the lower part of the user's fingers would be disposed when grabbing the handheld controller; select hand ventilation areas in the outer palm grip areas corresponding to where a user's palms would be disposed when grabbing the handheld controller, inner finger grip areas corresponding to where at least an upper portion of a user's fingers would be disposed when grabbing the handheld controller, areas corresponding to where the thumbs and adjoining palm areas would be disposed when grabbing the handheld controller, areas corresponding to where the lower part of the user's fingers would be disposed when grabbing the handheld controller, the select hand ventilation areas comprising select areas where air moves therethrough to the user's hand to cool the user's hand during use of the handheld controller and including multiple ventilation holes therein to allow air to move from an inside of the handheld controller housing to an outside of the handheld controller housing; means for manipulating objects on a video screen; and an internal fan assembly within the handheld controller to move air through the select hand ventilation areas from the inside of the housing to the outside of the housing.

Implementations of the aspect of the invention described immediately above may include one or more of the following. The select hand ventilation areas include at least one spacer to space the user's hands from the multiple ventilation holes. The internal fan assembly is a multi-speed fan assembly and further including a multi-position switch carried by the housing to control the multi-speed fan assembly. The handheld controller housing includes a central section with the internal fan assembly located therein. The handheld controller housing includes a central section with a top and a bottom, and the handheld controller housing includes a fan intake in the bottom of the central section where air is drawn from outside the handheld controller into the housing and to the internal fan assembly.

A further aspect of the invention involves a handheld controller for manipulating objects on a video screen. The handheld controller includes a handheld controller housing including a right handgrip and a left handgrip where a user grips the handheld controller with a right hand and a left hand, respectively; more than one hand ventilation area where air moves through the ventilation area to the user's hand to cool the user's hand during use of the handheld controller, the more than one hand ventilation area including multiple ventilation holes therein to allow air to move from an inside of the handheld controller housing to an outside of the handheld controller housing, wherein the more than one hand ventilation area includes at least one spacer to space the user's hands from the multiple ventilation holes; means for manipulating objects on a video screen; and an internal fan assembly within the handheld controller to move air through the multiple ventilation holes from the inside of the housing to the outside of the housing.

Implementations of the aspect of the invention described immediately above may include one or more of the following. The internal fan assembly is a multi-speed fan assembly and further including a multi-position switch carried by the housing to control the multi-speed fan assembly. The handheld controller housing includes a central section with the internal fan assembly located therein. The handheld controller housing includes a central section with a top and a bottom, and the handheld controller housing includes a fan intake in the bottom of the central section where air is drawn from outside the handheld controller into the housing and to the internal fan assembly.

Further objects and advantages will be apparent to those skilled in the art after a review of the drawings and the detailed description of the preferred embodiments set forth below.

### BRIEF DESCRIPTION OF THE DRAWINGS

FIG. 1 is a top perspective view of an embodiment of a handheld controller.

FIG. 2 is a right side elevational view of the handheld controller illustrated in FIG. 1.

FIG. 3 is a front elevational view of the handheld controller illustrated in FIG. 1.

FIG. 4 is a rear elevational view of the handheld controller illustrated in FIG. 1.

FIG. 5 is a bottom plan view of the handheld controller illustrated in FIG. 1.

FIG. 6 is a top plan view of the handheld controller illustrated in FIG. 1.

FIG. 7 is an exploded bottom perspective view of the handheld controller illustrated in FIG. 1 with a lower housing member of the handheld controller separated from an upper housing member.

FIG. 8 is an exploded bottom perspective view of the upper housing member of the handheld controller illustrated in FIG. 1 with some of the internal components of the handheld controller shown removed from the upper housing member.

FIG. 9 is an exploded bottom perspective view similar to FIG. 8 and shows a main printed circuit board and plastic analog component mount of the handheld controller removed from the upper housing member.

FIG. 10 is an exploded bottom perspective view similar to FIGS. 8 and 9 and shows a plastic analog component mount, analog stick printed circuit board, and numerous input members of the handheld controller removed from the upper housing member.

### DETAILED DESCRIPTION OF PREFERRED EMBODIMENTS

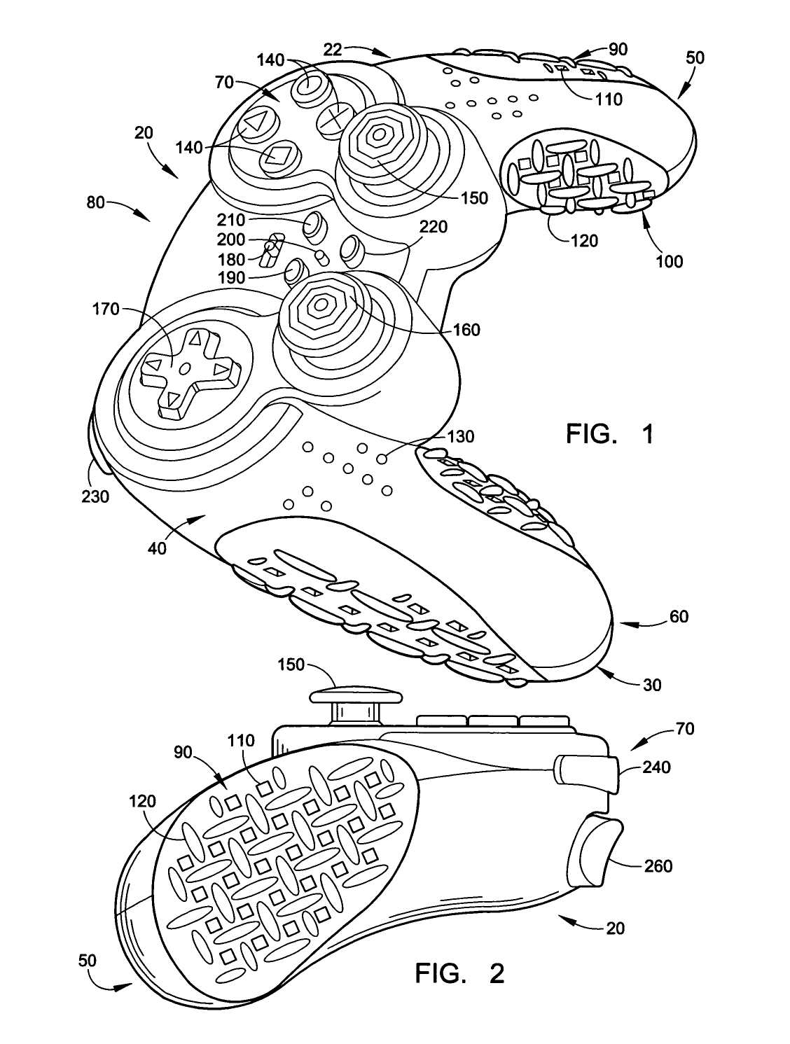

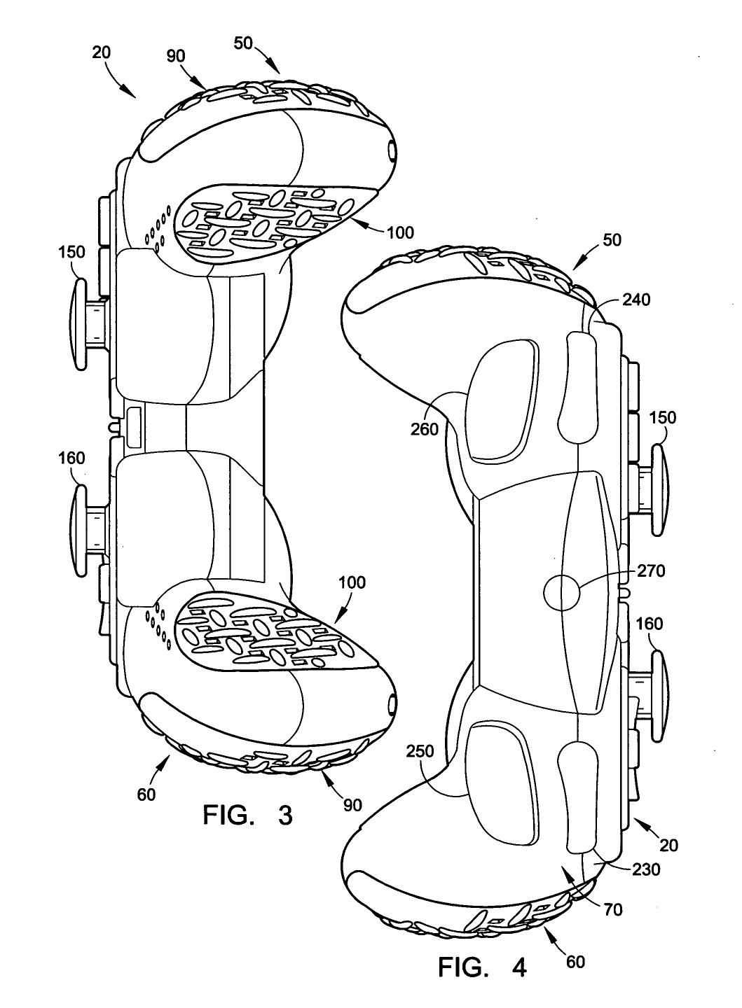

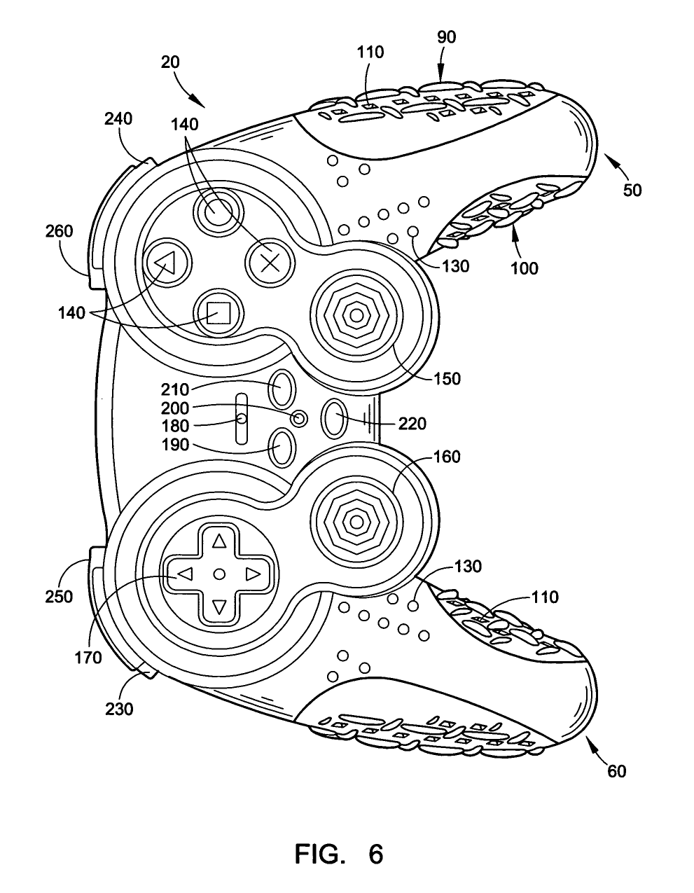

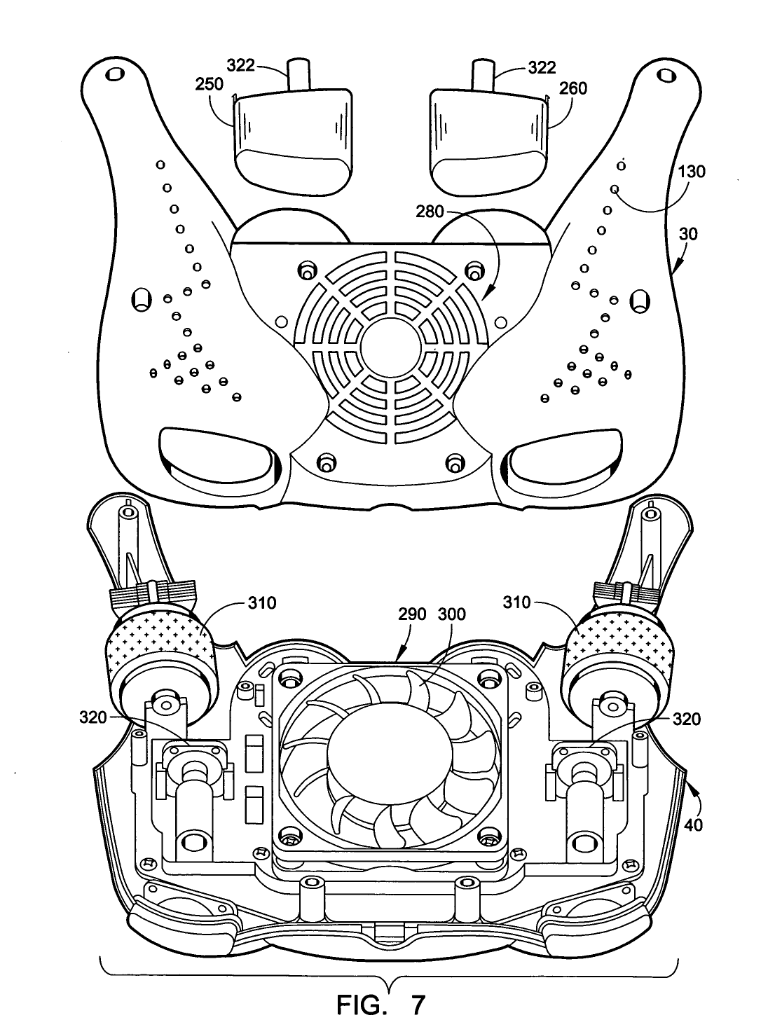

With reference to FIGS. 1-10, and initially to FIGS. 1-6, an embodiment of a handheld controller 20 that is used to manipulate objects on a video screen and is ventilated to keep a user's hand dry and prevent perspiration will now be described.

The handheld controller 20 includes a housing 22 with a lower housing member 30 and an upper housing member 40 that house electronics for operation of the handheld controller 20 and an internal fan. The handheld controller 20 includes a right handgrip 50, a left handgrip 60, and a plurality of input members 70 in a central section 80 of the handheld controller 20, generally between the handgrips 50, 60.

Each handgrip 50, 60 includes an outer palm grip 90 and an inner finger grip 100. The outer palm grip 90 corresponds to where a user would place one's palms while holding the handheld controller 20 and the inner finger grip 100 corresponds to where a user would place one's fingers (other than the thumbs) while holding the handheld controller 20. In the embodiment shown, each grip 90, 100 is made of rubber and includes ventilation holes 110 and cross-shaped protruding grip members 120.

In a manner described in more detail below, during use of the handheld controller 20, air flows through the ventilation holes 110, from inside the housing 22 to outside the housing 22, to cool the user's hands. The ventilation holes 110 in the outer palm grip 90 correspond to where a user's palm would contact the outer palm grip 90 for air cooling of the user's palm. The ventilation holes 110 in the inner finger grip 100 correspond to where an upper part of the user's fingers would contact the inner finger grip 100 for air cooling of the upper part of the user's fingers.

In alternative embodiments of the ventilation holes 110 of the handheld controller 20, the ventilation holes 110 may have a different shape and/or configuration than that shown in FIGS. 1-6.

In alternative embodiments, the handgrips 50, 60 may each have no grips 90, 110, only one of the two types of grips 90, 110, or at least the two types of grips 90, 110. In further embodiments, the grip members 120 may have a different configuration. Important aspects of the grip members 120 are that they provide a location for a user's fingers to engage and grip the handgrips 50, 60 without slippage and they space the user's fingers and palms from the ventilation holes 110 so that the fingers and palms do not block the ventilation holes 110, allowing the fingers and palms to be efficiently and effectively air cooled.

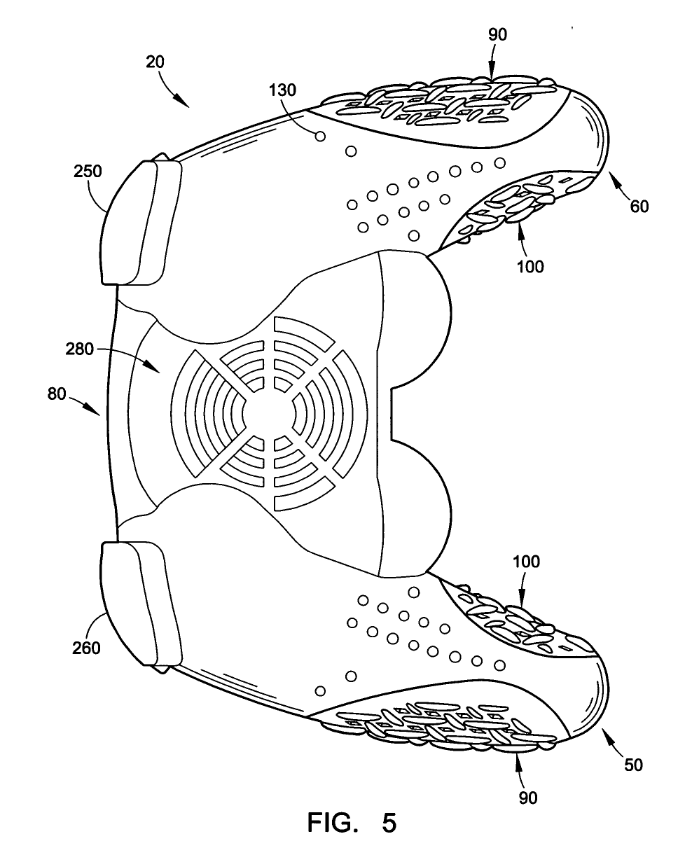

Between the grips 90, 100, additional ventilation holes 130 are disposed in both a bottom of the lower housing member 30 and a top of the upper housing member 40 in the handgrips 40, 50 for emitting air from the inside of the housing 22 to the outside of the housing 22 to cool the user's hands. The additional ventilation holes 130 in the upper side of the handgrips 50, 60 correspond to where the thumbs and adjoining palm areas would be located during use of the handheld controller 20 for air cooling of the thumbs and adjoining palm areas. With reference to FIG. 5, the additional ventilation holes 130 in the bottom side of the handgrips 50, 60 correspond to where a lower part of the user's fingers would be located during use of the handheld controller 20 for air cooling of the lower part of the user's fingers.

The input members 70 in a top side of the central section 80 include pressure-sensitive action buttons 140, a right rubberized analog stick 150, a left rubberized analog stick 160, a cross-shaped directional pad 170, a fan level switch 180, a select button 190, a mode indicator LED 200, a start switch 210, and a digital/analog mode button 220.

With reference to FIGS. 2 and 4, the input members 70 in a rear end of the central section 80 include a left pressure-sensitive shoulder action button 230, a right pressure-sensitive shoulder action button 240, a left pressure-sensitive trigger-shaped action button 250, and a right pressure-sensitive trigger-shaped action button 260. The housing 22 includes a controller cord cutout 270 where a controller cord connects the handheld controller 20 to a system port of a system (e.g., video game system such as, but not limited to, XBOX® by Microsoft Corporation, PLAYSTATION® II by Sony Corporation, GAMECUBE® by Nintendo Corporation) for supplying power for the internal fan and other electronic components of the handheld controller 20 and two-way communication of electrical signals.

With reference to FIG. 5, a fan air intake grill 280 is disposed in a bottom side of the central section 80. Air is drawn into the housing 22 by an internal fan through the openings in the fan air intake grill 280. A filter may be disposed underneath the openings in the fan air intake grill 280, the ventilation holes 110, and the additional ventilation holes 130 to prevent dirt and other debris from entering the inside of the housing 80. Positioning the fan air intake grill 280 and fan 300 in the location shown inhibits the user from hearing fan noise, directs air towards the grip ends, causes air to travel across the circuit boards allowing for cooler operation and a longer anticipated operational life.

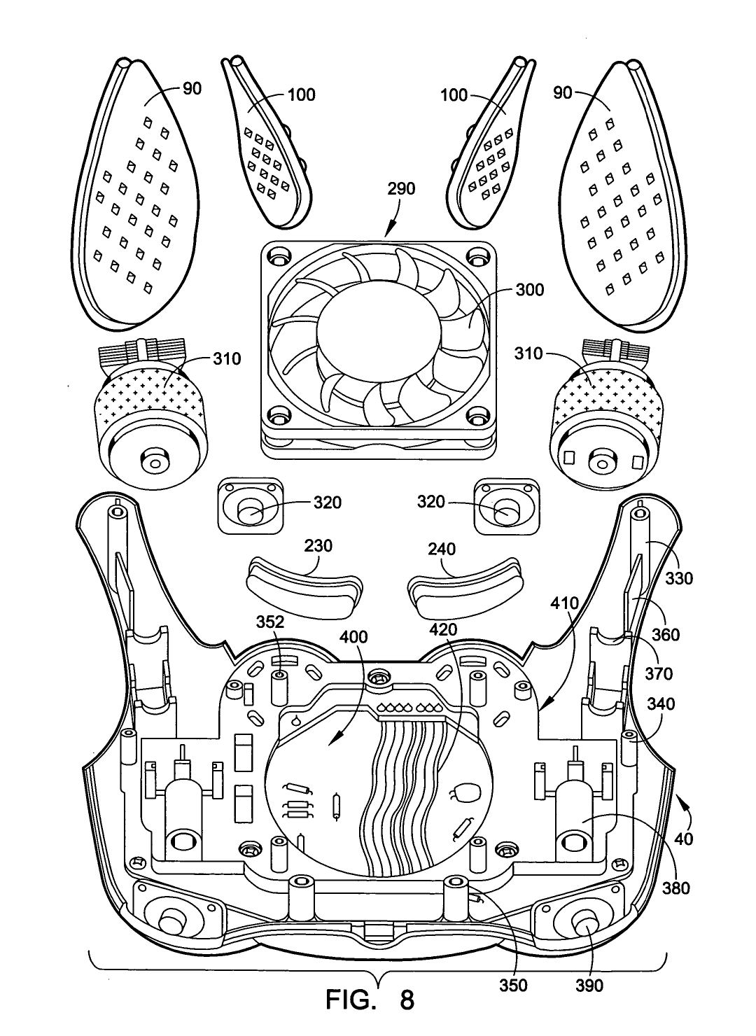

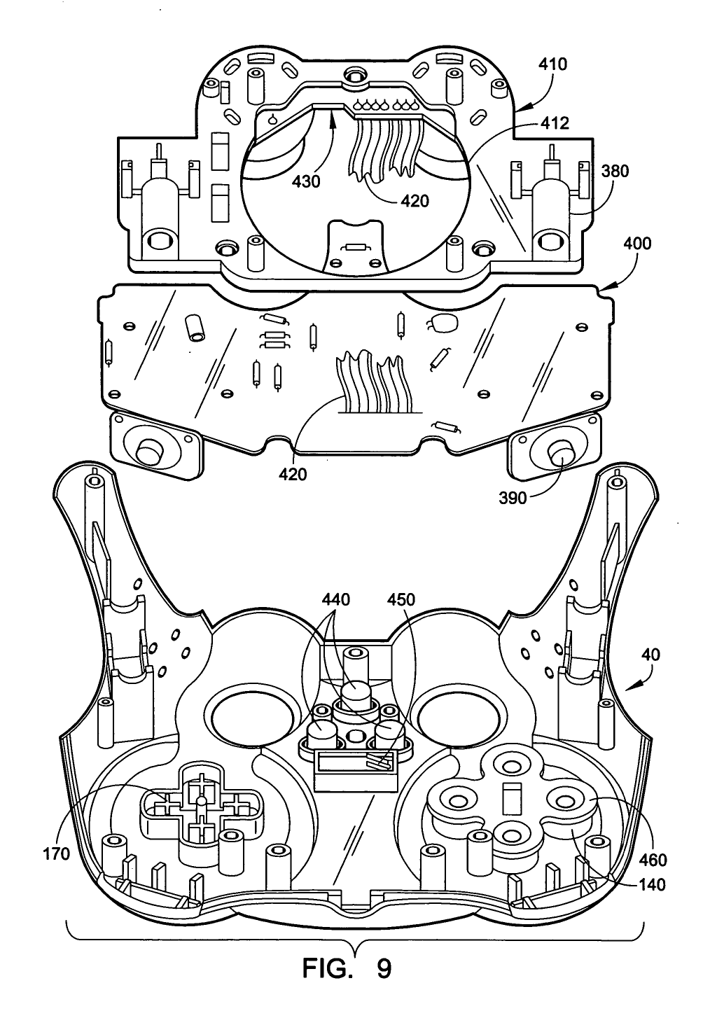

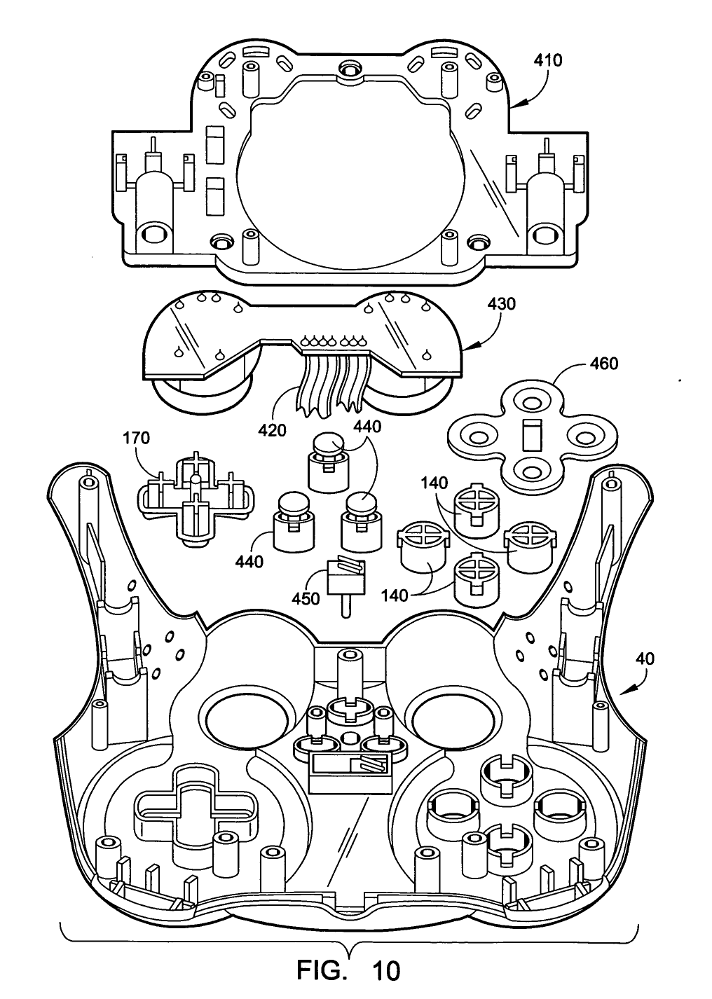

With reference to FIGS. 7-10, and initially FIGS. 7 and 8, some of the internal components of the handheld controller 20 will now be described. FIG. 7 is an exploded bottom perspective view of the handheld controller 20 and shows the lower housing member 30 of the handheld controller 20 separated from the upper housing member 40. FIG. 8 is an exploded bottom perspective view of the upper housing member 40 of the handheld controller 20 with some of the internal components of the handheld controller 20 shown removed from the upper housing member 40. The internal components shown removed include a fan assembly 290 with a bearingless, brushless fan 300, vibration motors 310 for causing a vibration sensation in the handheld controller 20 upon receiving certain electrical signals, and carbon button contacts 320 that are operatively associated with trigger button posts 322. Outer palm grips 90, inner finger grips 100, and shoulder action buttons 230, 240 are shown removed from the handheld controller 20. Additional components shown in FIGS. 7 and 8 include lower screw posts 330, middle screw posts 340, upper screw posts 350, fan mount posts 352, motor balance 360, motor mount 370, trigger button post guide 380, button contacts 390 for shoulder action buttons 230, 240, printed circuit board 400, plastic analog component mount 410 with cutout 412 to improve air distribution in the interior cavity of the housing 22, and ribbon 420 connecting analog stick printed circuit board 430 (FIGS. 9, 10) to main printed circuit board 440.

FIG. 9 shows the main printed circuit board 400 and the plastic analog component mount 410 of the handheld controller 20 removed from the upper housing member 40 and FIG. 10 shows the plastic analog component mount 410 separated from the analog stick printed circuit board 430, and numerous components of input members 70 of the handheld controller 20 removed from the upper housing member 40. Some of the components of input members 70 shown in FIGS. 9 and 10 include button contacts 440 for select button 190, start switch 210, and digital/analog mode button 220; switch contacts 450 for fan level switch 180; the cross-shaped directional pad 170; and carbon button contact 460 for the action buttons 140.

The above shown, described electronics are used to translate movement of the input members 70 into signals for manipulating objects on a video screen in a well-known manner.

In an alternative embodiment of the handheld controller 20, the handheld controller 20 and the system may include wireless transmission devices (e.g., RF, infrared transmitter/receiver) for wireless communication therebetween. In such an embodiment, the handheld controller 20 includes its own on-board power supply (e.g., rechargeable battery/batteries).

The handheld controller 20 will now be described in use. When the handheld controller 20 is connected to a system port of a system (e.g., video game system such as, but not limited to, XBOX® by Microsoft Corporation, PLAYSTATION® II by Sony Corporation, GAMECUBE® by Nintendo Corporation) by a cord, to activate the fan assembly 290, the user switches the fan level switch 180 to a position “I”, the low fan speed position, or a position “II”, the high fan speed position. In position “I” or position “II”, power delivered from a system port and through the cord is used to run the motor/fan 300 of the fan assembly 290 at the designated speed level. The fan assembly 290 draws air from outside the handheld controller 20 through the gaps in the fan air intake grill 280 and through the fan assembly 290. Air is then blown through the housing 22 and into the handgrips 50, 60.

Air under pressure exits the handgrips 50, 60 through the ventilation holes 110, 130. Because the ventilation holes 110 in the outer palm grip 90 correspond to where a user's palm contacts the outer palm grip 90, air exiting the ventilation holes 110 in the outer grip 90 cools the user's palm. Because the ventilation holes 110 in the inner finger grip 100 correspond to where an upper part of the user's fingers contact the inner finger grip 100, air exiting the ventilation holes 110 in the inner finger grip 100 cools the upper part of the user's fingers. Not only do the grip members 120 provide a location for a user's fingers to engage and grip the handgrips 50, 60 without slippage, but the grip members 120 also space the user's fingers and palms from the ventilation holes 110 so that the fingers and palms do not block the ventilation holes 110, increasing the cooling effect on the fingers and palms in these areas. Because the additional ventilation holes 130 in the upper side of the handgrips 50, 60 correspond to where the thumbs and adjoining palm areas would be located during use of the handheld controller 20, air exiting the ventilation holes 130 in this area cools the thumbs and adjoining palm areas of the user's hands. Because the additional ventilation holes 130 in the bottom side of the handgrips 50, 60 correspond to where a lower part of the user's fingers would be located during use of the handheld controller 20, air exiting the ventilation holes 130 in this area cools the lower part of the user's fingers.

Although not shown, adjacent the ventilation holes 130, the handheld controller 20 may include one or more spacers to space the user's hand from the holes 130 in a manner similar to that described above for the grip member 120.

Providing select, defined ventilation areas in one or more of the outer palm grip area of the handgrips 50, 60, the inner finger grip area of the handgrips 50, 60, the area of the handgrips 50, 60 in the upper side corresponding to where the thumbs and adjoining palm areas would be located, and the area of the handgrips 50, 60 in the lower side corresponding to where the lower part of the user's fingers would be located during use of the handheld controller 20, maximizes the flow rate through the holes 110, 130, compared to locating ventilation holes through the entire surface of the handgrips 50, 60, to inhibit the development of perspiration in the entire front (i.e., palm side) of the user's hands.

It will be readily apparent to those skilled in the art that still further changes and modifications in the actual concepts described herein can readily be made without departing from the spirit and scope of the invention as defined by the following claims.

1. A handheld controller for manipulating objects on a video screen, comprising:
a handheld controller housing including a right handgrip and a left handgrip where a user grips the handheld controller with a right hand and a left hand, respectively;
more than one select hand ventilation area where air moves through the ventilation area to the user's hand to cool the user's hand during use of the handheld controller, the more than one select hand ventilation area including multiple ventilation holes therein to allow air to move from an inside of the handheld controller housing to an outside of the handheld controller housing, the more than one select hand ventilation area located in less than the entirety of at least the right handgrip and the left handgrip,
wherein the right handgrip and the left handgrip include outer palm grip areas corresponding to where a user's palms would be disposed when grabbing the handheld controller, and the more than one select hand ventilation area located in less than the entirety of at least the right handgrip and the left handgrip includes a select ventilation area located only in the outer palm grip areas of the right handgrip and the left handgrip;
means for manipulating objects on a video screen; and
an internal fan assembly within the handheld controller to move air through the multiple ventilation holes from the inside of the housing to the outside of the housing.

2. (canceled)

3. The handheld controller of claim 1, wherein the right handgrip and the left handgrip include inner finger grip areas corresponding to where at least an upper portion of a user's fingers would be disposed when grabbing the handheld controller, and the more than one select hand ventilation area located in less than the entirety of at least the right handgrip and the left handgrip further includes a select ventilation area located only in the inner finger grip areas of the right handgrip and the left handgrip, in addition to the select ventilation area located only in the outer palm grip areas.

4. The handheld controller of claim 3, wherein the right handgrip and the left handgrip include areas corresponding to where the thumbs and adjoining palm areas would be disposed when grabbing the handheld controller, and the more than one select hand ventilation area located in less than the entirety of at least the right handgrip and the left handgrip further includes a select ventilation area located only in the areas corresponding to where the thumbs and adjoining palm areas would be disposed when grabbing the handheld controller of the right handgrip and the left handgrip, in addition to the select ventilation area located only in the outer palm grip areas and the select ventilation area located only in the inner finger grip areas.

5. The handheld controller of claim 4, wherein the right handgrip and the left handgrip include areas corresponding to where the lower part of the user's fingers would be disposed when grabbing the handheld controller, and the more than one select hand ventilation area located in less than the entirety of at least the right handgrip and the left handgrip further includes a select ventilation area located only in the areas corresponding to where the lower part of the user's fingers would be disposed when grabbing the handheld controller of the right handgrip and the left handgrip in addition to the select ventilation area located only in the outer palm grip areas, the select ventilation area located only in the inner finger grip areas, and the select ventilation area located only in the areas corresponding to where the lower part of the user's fingers would be disposed when grabbing the handheld controller.

6. The handheld controller of claim 1, wherein the more than one select hand ventilation area includes at least one spacer to space the user's hands from the multiple ventilation holes.

7. The handheld controller of claim 1, wherein the internal fan assembly is a multi-speed fan assembly and further including a multi-position switch carried by the housing to control the multi-speed fan assembly.

8. The handheld controller of claim 1, wherein the handheld controller housing includes a central section with the internal fan assembly located therein.

9. The handheld controller of claim 1, wherein the handheld controller housing includes a central section with a top and a bottom, and the handheld controller housing includes a fan intake in the bottom of the central section where air is drawn from outside the handheld controller into the housing and to the internal fan assembly.

10. A handheld controller for manipulating objects on a video screen, comprising:
a handheld controller housing including a right handgrip and a left handgrip where a user grips the handheld controller with a right hand and a left hand, respectively, the right handgrip and the left handgrip including outer palm grip areas corresponding to where a user's palms would be disposed when grabbing the handheld controller, inner finger grip areas corresponding to where at least an upper portion of a user's fingers would be disposed when grabbing the handheld controller, areas corresponding to where the thumbs and adjoining palm areas would be disposed when grabbing the handheld controller, areas corresponding to where the lower part of the user's fingers would be disposed when grabbing the handheld controller;
select hand ventilation areas located only in the following: outer palm grip areas corresponding to where a user's palms would be disposed when grabbing the handheld controller, inner finger grip areas corresponding to where at least an upper portion of a user's fingers would be disposed when grabbing the handheld controller, areas corresponding to where the thumbs and adjoining palm areas would be disposed when grabbing the handheld controller, areas corresponding to where the lower part of the user's fingers would be disposed when grabbing the handheld controller,
the select hand ventilation areas comprising select areas where air moves therethrough to the user's hand to cool the user's hand during use of the handhold controller and including multiple ventilation holes therein to allow air to move from an inside of the handheld controller housing to an outside of the handheld controller housing;
means for manipulating objects on a video screen; and
an internal fan assembly within the handheld controller to move air through the select hand ventilation areas from the inside of the housing to the outside of the housing.

11. The handheld controller of claim 10, wherein the select hand ventilation areas include at least one spacer to space the user's hands from the multiple ventilation holes.

12. The handheld controller of claim 10, wherein the internal fan assembly is a multi-speed fan assembly and further including a multi-position switch carried by the housing to control the multi-speed fan assembly.

13. The handheld controller of claim 10, wherein the handheld controller housing includes a central section with the internal fan assembly located therein.

14. The handheld controller of claim 10, wherein the handheld controller housing includes a central section with a top and a bottom, and the handheld controller housing includes a fan intake in the bottom of the central section where air is drawn from outside the handheld controller into the housing and to the internal fan assembly.

15. A handheld controller for manipulating objects on a video screen, comprising:
a handheld controller housing including a right handgrip and a left handgrip where a user grips the handheld controller with a right hand and a left hand, respectively;
more than one hand ventilation area where air moves through the ventilation area to the user's hand to cool the user's hand during use of the handheld controller, the more than one hand ventilation area including multiple ventilation holes therein to allow air to move from an inside of the handheld controller housing to an outside of the handheld controller housing, wherein the more than one hand ventilation area includes multiple small spacers to space the user's hands from the multiple ventilation holes, the number of spacers and size of the spacers substantially corresponding to the multiple ventilation holes in the ventilation area;
means for manipulating objects on a video screen; and
an internal fan assembly within the handheld controller to move air through the multiple ventilation holes from the inside of the housing to the outside of the housing.

16. The handheld controller of claim 15, wherein the internal fan assembly is a multi-speed fan assembly and further including a multi-position switch carried by the housing to control the multi-speed fan assembly.

17. The handheld controller of claim 15, wherein the handheld controller housing includes a central section with the internal fan assembly located therein.

18. The handheld controller of claim 15, wherein the handheld controller housing includes a central section with a top and a bottom, and the handheld controller housing includes a fan intake in the bottom of the central section where air is drawn from outside the handheld controller into the housing and to the internal fan assembly.
